(19) United States
(12) Patent Application Publication
(10) Pub. No.: US 2024/0075342 A1
(43) Pub. Date: Mar. 7, 2024

(54) SYSTEMS AND TECHNIQUES FOR DATA ASSISTED SPORT AUGMENTATION

(71) Applicant: NAGRAVISION SARL, CHESEAUX-SUR-LAUSANNE (CH)

(72) Inventor: Benjamin Gidley, Cwmbran (GB)

(73) Assignee: NAGRAVISION SARL, CHESEAUX-SUR-LAUSANNE (CH)

(21) Appl. No.: 18/239,588

(22) Filed: Aug. 29, 2023

Related U.S. Application Data
(60) Provisional application No. 63/403,185, filed on Sep. 1, 2022.

(51) Int. Cl. A63B 24/00; G06T 7/00; G06T 7/20; G06T 19/00; G06V 20/20; G06V 20/40; G06V 40/10; G06V 40/20

(52) U.S. Cl. CPC A63B 24/0021; G06T 7/0002; G06T 7/20; G06T 19/006; G06V 20/20; G06V 20/42; G06V 40/10; G06V 40/23; A63B 2024/0028; A63B 2024/0037; G06T 2207/10016; G06T 2207/30196; G06T 2207/30224; G06T 2207/30241

(57) ABSTRACT

The present disclosure generally relates to sport augmentation systems. For example, aspects of the present disclosure include systems and techniques for assessing a path of a ball during a sporting session to be used to augment a sporting experience. On example method includes receiving one or more frames capturing image data associated with movement of a ball on a surface during a sporting session, determine a state associated with throwing the ball based on the one or more frames, perform an assessment of the surface on which the ball is thrown, predict a path of the ball as thrown on the surface based on the state associated with the ball and the assessment of the surface, and output an indication of the path to be displayed on a display element.

### CROSS-REFERENCE TO RELATED APPLICATIONS

The present patent application claims the priority benefit of U.S. Provisional Patent Application No. 63/403,185 filed Sep. 1, 2022, the disclosures of which are incorporated by reference herein.

### FIELD

The present disclosure generally relates to sport augmentation systems. For example, aspects of the present disclosure include systems and techniques for assessing a path of a ball during a sporting session to be used to augment a sporting experience.

### BACKGROUND

Televised sports have become a popular pastime for many. Increasing enjoyment in watching sports is important for individuals and for companies that profit from showing advertisements during sporting sessions. This is especially true for some sports where playing the sport is more enjoyable than merely watching the sport on television. Therefore, apparatus and techniques are needed to augment the sport-watching experience.

### SUMMARY

Certain aspects provide an apparatus for path analysis. The apparatus generally includes a memory and one or more processors coupled to the memory. The one or more processors may be configured to: receive one or more frames capturing image data associated with movement of a ball on a surface during a sporting session; determine a state associated with throwing the ball based on the one or more frames; perform an assessment of the surface on which the ball is thrown; predict a path of the ball as thrown on the surface based on the state associated with the ball and the assessment of the surface; and output an indication of the path to be displayed on a display element.

Certain aspects provide a bowling ball. The bowling ball generally includes a receiver configured to receive a signal indicating an interaction of the bowling ball with a virtual representation of an obstacle on a bowling lane, and a haptic device coupled to the receiver, wherein the haptic device is configured to change a movement of the bowling ball based on the signal.

Certain aspects provide a system for path analysis. The system generally includes a movement assessment component configured to determine a state associated with throwing a ball based on one or more frames capturing image data associated with movement of the ball on a surface during a sporting session, and a surface assessment component communicably coupled to the movement assessment component and configured to perform an assessment of the surface on which the ball is thrown. The system may also include a path prediction component communicably coupled to the movement assessment component and the surface assessment component, the path prediction component being configured to predict a path of the ball as thrown on the surface based on the state associated with the ball and the assessment of the surface, and output an indication of the path to be displayed on a display element.

### BRIEF DESCRIPTION OF THE DRAWINGS

Illustrative embodiments of the present application are described in detail below with reference to the following drawing figures:

FIG. 1 is a diagram illustrating an example engagement system implemented using a computing device, in accordance with some examples.

FIG. 2 illustrates an engagement system implemented for bowling, in accordance with certain aspects of the present disclosure.

FIG. 3 illustrates example operations for path analysis, in accordance with certain aspects of the present disclosure.

FIG. 4 is a block diagram illustrating example components of a bowl, in accordance with certain aspects of the present disclosure.

FIG. 5 illustrates example operations for interactive bowling, in accordance with certain aspects of the present disclosure.

FIG. 6 illustrates an architecture of a computing system.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Making sports more engaging to watch on television is important to content providers, as it translates to larger audiences and higher advertisement revenues. Increasing sports engagement can increase audiences and may be achieved using advances in technology. One sport that can take advantage of using digital services to increase engagement is bowling, yet the techniques described herein may be applied to any suitable sport. 10 and 9 pin bowling are technical precision sports played in controlled environments. Providing digital services for bowling is generally based around the data gathered from the bowling machines (e.g., also referred to as Pinsetters) which calculate the score. Bowling may not be exciting to watch for some because once an experienced bowler has gained an understanding of a lane, the bowler can repeat the same throw repeatedly. To make it more engaging and accessible, some aspects of the present disclosure use cameras, machine vision, augmented reality (AR), and internet services to create an exciting sports watching experience.

Certain aspects provide a sport augmentation system that provides data analysis to perform predictions and augmentation of sports such as bowling. For example, specifically for bowling, the sport augmentation system may provide spatial recording. The system may record the path of the bowl (e.g., as a three-dimensional (3D) object) based on computer vision from fixed cameras. As used herein, computer vision generally refers to processing of sensor data including images or video captured by cameras. The path of the bowl may be overlaid on a display showing the bowling environment, increasing engagement in the sport. The camera may capture the location (e.g., position), motion (e.g., motion vector), and/or spin of the bowl as the bowl moves down lane. This information may be displayed to viewers. For instance, the path of bowl may be shown on television after a bowler has bowled, or in some cases, the path of the bowl may be predicted and shown prior to or while the bowler is throwing the bowling ball.

The system may predict the bowling path from the posture of the bowler before the bowler actually throws the bowl. The bowler's posture may be recorded using computer vision (e.g., analysis of captured video of the bowler) and used to predict the likely outcome of the bowl. The prediction may be displayed, and in some cases, overlaid on a video of the bowling environment. In some cases, the prediction may be used to visualize the predicted outcome of a bowl in AR, online, video overlays, or in bowling center screens.

In some aspects, the system described herein provides a virtual bowling game experience across centers with AR view. For instance, two bowlers may compete virtually. To do so, scores and spatial recording may be communicated to allow each bowler to see his or her opponent's bowl overlaid on their local center in AR. For instance, each bowler may have an AR device in communication with a sport augmentation system. Each sport augmentation system may capture throw data (e.g., in real time) of a respective bowler using cameras. The throw data may be communicated between the sport augmentation systems, each system processing the data and generating graphics to be displayed on a respective AR device showing a path of a throw of the respective bowler's opponent.

In some aspects, the system may provide virtual bowling with automatic throws. The system may allow two bowlers to compete with an automatic throwing machine (e.g., also referred to herein as a “bowl thrower”) that delivers a bowl along the same path as a competitor based on spatial recording. For instance, two bowlers may be at different bowling centers. A first bowler may bowl, and the path of the bowl may be identified using computer vision. The identified path may be communicated to an automatic throwing machine located in the same bowling center as the second bowler. The automatic throwing machine may bowl such that the bowling ball tracks the bowl path as identified using computer vision for the first bowler. The second bowler may then bowl, and computer vision may be used to identify the path of the bowl for the second bowler, which may be communicated to an automatic bowling machine in the same facility as the first bowler. In this manner, the bowlers may compete while at different bowling centers.

In some aspects, the system may allow for an AR view of a ghost bowl path. For example, using AR glasses, a bowler may see a path, spin, and/or velocity (e.g., a translucent path) of a bowl corresponding to the bowler's (or other bowler's) previous bowls. In other words, the path of the previous bowl may be identified using computer vision and stored. The stored path may be then used to generate graphical data to be displayed on AR glasses, allowing the bowler to see the path of his or her previous bowl.

In some aspects, the system provides an AR view of novelty bowling. For example, the system may create a novelty game for bowling with obstacles and graphics in AR. A rock or creature may be placed on the bowling lane in AR view, as an example, and the bowler may have to avoid the rock or creature when bowling as part of the sport. In some cases, bowling may be implemented using an interactive bowling ball or lane. Haptic feedback may be placed in the bowl or bowling lane so that the direction of travel of the bowl may be changed. For instance, if a bowler bowls into an obstacle shown in AR view, the direction of the bowl may be changed so that the bowl goes into the gutter. In certain aspects, the system may provide lane quality analysis. For example, spatial analysis may be used for lane calibration to identify un-even lane surfaces (e.g., caused by warping of the surface) and issues with coatings (e.g., causing high friction areas on the surface), as described in more detail herein.

The aspects of the present disclosure provide a system for increasing sports engagement with elements providing improved experiences in the bowling center and elements running as services in the cloud. While examples provided herein are described with respect to the sport of bowling to facilitate understanding, the aspects of the present disclosure may be applied to any suitable sport, such as golfing.

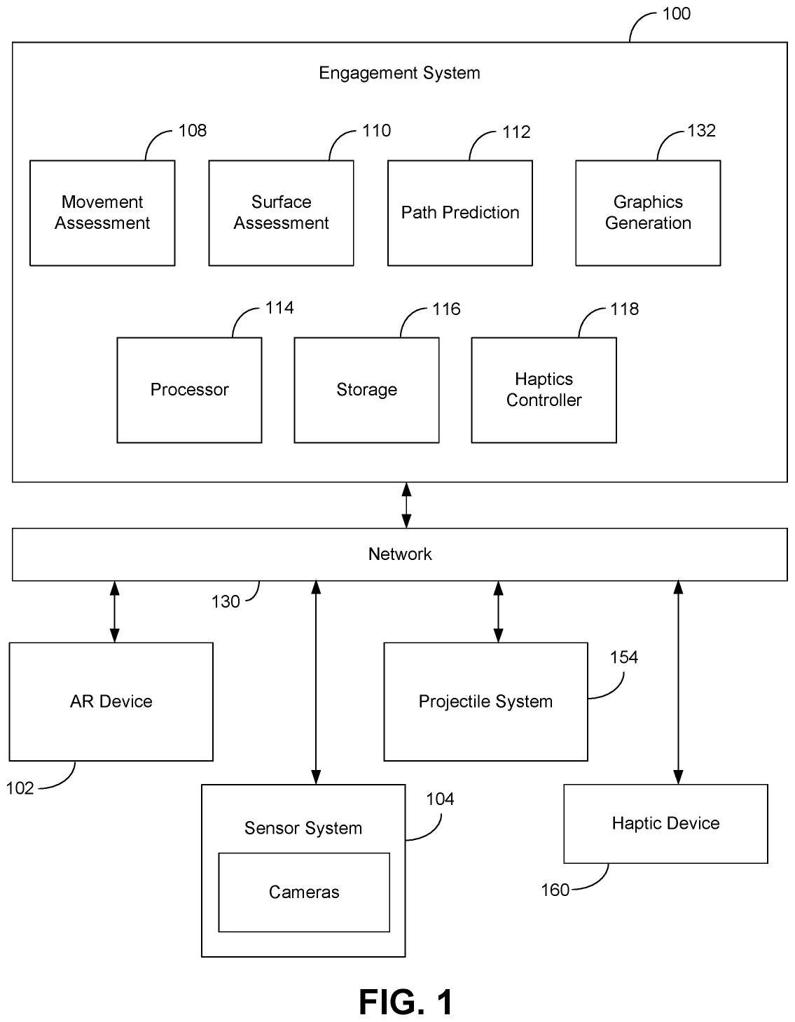

FIG. 1 is a diagram illustrating an example engagement system 100 implemented using a computing device, in accordance with some examples. In the example shown, the engagement system 100 may include storage 116 and processor 114. The storage 116 can include any storage device(s) for storing data. The storage 116 can store data from any of the components of the engagement system 100.

In some implementations, the processor 114 can include a central processing unit (CPU), a graphics processing unit (GPU), a digital signal processor (DSP), any combination thereof, or other type of processor. As shown, engagement system 100 may include a movement assessment component 108. The movement assessment component 108 may assess movement on a ball (e.g., as thrown or as moving on a surface). The engagement system 100 may also include a surface assessment component 110, which may assess the surface on which the ball moves. The assessment of the surface and the movement of the ball may be performed based on sensor data from a sensor system 104. The sensor data may be received via network 130. The sensor data may include one or more frames (e.g., images) from one or more cameras of the sensor system 104.

The engagement system 100 may also include path prediction component 112 which may predict, based on the assessment of the surface and the movement of the ball, a path that the ball will take. The engagement system 100 may include a graphics generation component 132, which may render graphics to be displayed. The rendered graphics may show the predicted path of the ball. The graphics may be displayed on an AR device 102 through a network 130. In some cases, the engagement system 100 may include a haptics controller 118. The haptics controller 118 may control a haptic device, such as the haptic device 160 (e.g., through network 130).

In some aspects, at least one of the movement assessment component 108, the surface assessment component 110, the path prediction component 112, the graphics generation component 132, or the haptics controller 118 may be implemented as part of the processor 114 and/or implemented as instructions in storage 116. At least one of the movement assessment component 108, the surface assessment component 110, the path prediction component 112, the graphics generation component 132, or the haptics controller 118 may be implemented in hardware, software, or a combination of hardware and software. In some aspects, at least one of the movement assessment component 108, the surface assessment component 110, the path prediction component 112, the graphics generation component 132, or the haptics controller 118 may be implemented by or in the same hardware, software, or combination of hardware and software (e.g., by the same processor). In some aspects, at least one of the movement assessment component 108, the surface assessment component 110, the path prediction component 112, the graphics generation component 132, or the haptics controller 118 may be implemented by or in separate hardware, software, or combination of hardware and software.

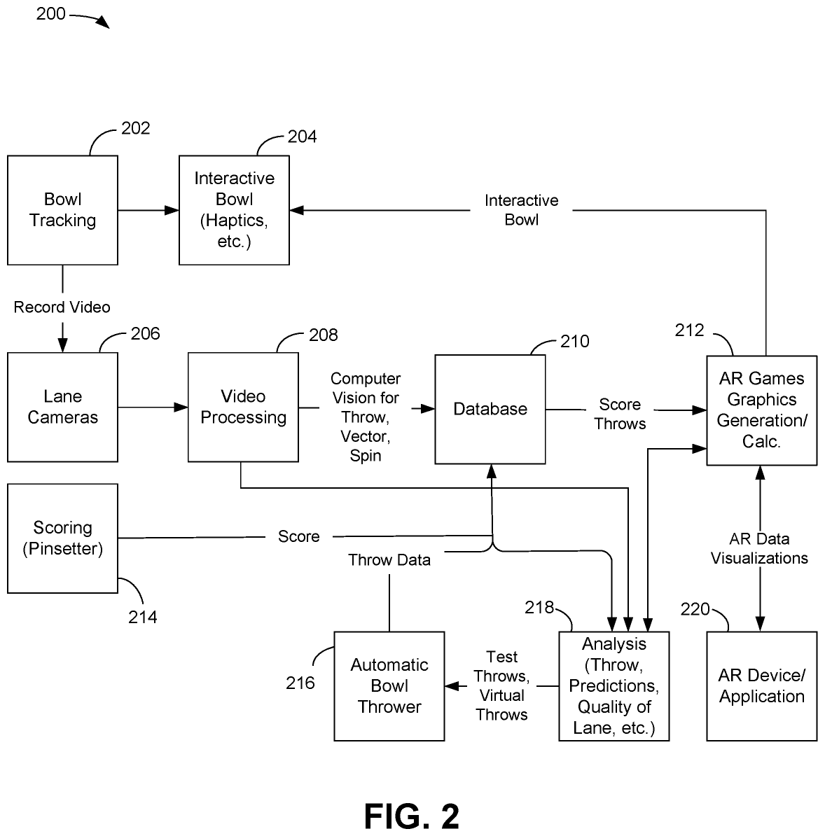

FIG. 2 illustrates an engagement system 200 implemented for bowling, in accordance with certain aspects of the present disclosure. The engagement system 200 may be implemented using components described with respect to FIG. 1. As shown, at block 202, a bowl may be tracked (e.g., using one or more cameras or using a tracking element in a bowling ball). At block 206, one or more lane cameras may be used to capture visuals of a surface such as a bowling lane. While a camera is described as an example of a type of sensor for capturing surface data, any suitable sensor may be used. For instance, a 3D sensors may be used to detect warping on the surface. In some aspects, cameras may capture a user throwing a ball (e.g., the bowler). While a single camera may be used in some implementations, multiple cameras may be implemented to increase accuracy and provide wider coverage of the sporting environment in some cases. The output of the one or more cameras may be provided to a video processing component 208.

When a bowl occurs, the path of the bowl may be detected as the bowl proceeds down the lane over time. This is achieved by analysing video frames from the lane camera using the video processing component 208. The cameras may be fixed cameras in some cases but may be mobile cameras in other cases. Logic may be used to move the mobile camera and locate the lane to capture the video frames.

The video processing component 208 may implement computer vision to track the bowl. For each bowl, the video processing component 208 may build a three-dimensional (3D) model of size, surface pattern, and/or holes of the bowl, which may be used to identify the path of the bowl. In certain aspects, for added accuracy, the surface of the bowl may be printed with a non-symmetrical pattern to facilitate efficient locating of the bowl using video processing.

For each frame timecode, the video processing component 208 locates the lane. In each lane, the video processing component may detect a spherical object (e.g., to detect the bowl). Once the spherical object is detected, the video processing component 208 may record the location of the spherical object. In some aspects, any marks (e.g., holes or patterns) may be located on the surface of the spherical object. Using the located marks, the surface of the spherical object may be mapped to a 3D model of the bowl being used to establish the current orientation of the bowl. For a frame capturing the bowl near pins, the pins may be located by shape and mapped onto 3D models to establish the pins' location and orientation. For each frame, the detected location and orientation of the bowl and/or pins may be recorded into a database. For instance, as shown, the information indicating the throw such as a vector of motion and spin of the bowl may be stored in a database 210 (e.g., a throws database). The sequence of records indicating locations of the bowl form a vector of the bowl's motion in three dimensions. The sequence may be loaded into a 3D physics engine (e.g., game engine) to model the path of the bowl and the interactions with the pins using the recording to map the sequence to reality (e.g., allowing overlay on a display showing the reality in AR view). In some cases, the database 210 may also store information from a scoring machine 214 (e.g., Pinsetter machine), such as the score of the game.

In some aspects of the present disclosure, the video processing component 208 may track a bowl as it rotates in three dimensions. Various challenges may be associated with tracking a rotation of a bowl (e.g., or any smooth ball) as it may have little to no distinguishing features (e.g., except for the holes in the bowl used for throwing). As a result, some video frames may have little to no sight of the distinguishing features (e.g., holes), preventing the orientation and spin of the bowl to be established efficiently. In some aspects of the present disclosure, graphics may be printed on the bowl to distinguish the orientation of the bowl from each side. For example, the printed graphics may be a logo or any image that is asymmetrical such as an image of text, or any nonrepeating pattern of varying shapes. Thus, in this manner, from the angle of an observer (e.g., the camera), the captured video elements are unique for that orientation of the bowl, allowing the spin of the bowl to be properly detected. The orientation and spin information for the bowl may be stored in the database 210, as described.

In some aspects of the present disclosure, computer vision human posture analysis may be combined with a bowl motion path using a trained machine learning algorithm to predict the likely outcome of a bowl as a player is bowling. Computer vision human posture analysis provides an application showing a skeleton of human motion as a series of points and motion vectors. The posture information obtained from video frames may be stored in the database 210, in some aspects.

In some aspects, an analysis component 218 may be used to provide path predictions based on the video processing result described herein. For example, the analysis component 218 may predict a path or likely outcome of a bowl using posture information. The prediction of the bowl outcome may be improved, in some implementations, by providing as input, a surface assessment. For example, bowling lane specific quality analysis (e.g., whether there are any warps in the surface (e.g., bowling lane)) may be provided for accurate prediction of the path of the bowl. The surface assessment may be determined using computer vision via an output from the video processing component 208. In some cases, the output of the surface assessment may be stored in database 210 and retrieved by analysis component 218 for processing. For instance, the analysis component 218 may, based on video frames captured by cameras, identify the quality of the surface (e.g., bowling lane).

The output of the prediction by the analysis component 218 may be generated after the throw is made and/or before the throw is made. For instance, as the bowler winds up to throw the bowl, the video processing component 208 and analysis component 218 may use information from captured video frames to make a prediction of the bowl outcome (e.g., the path of the bowl). The bowl outcome may be provided, in real time, to the bowler and audience as a likely score with a visual of the path down the lane (e.g., via an AR device or video overlay). In some cases, based on the outcome prediction, the bowler may choose to correct their stance and/or reset their throw if they do not like the predicted score.

In some aspects, once the actual path data of the bowl is gathered, the path data may be imported into a 3D gaming and physics engine. The 3D gaming engine may generate an AR overlay of a remote bowler shown on top of a physical bowling alley, which may be shown throwing the bowl on a path corresponding to the path data. In some aspects, score and throws information may be provided to a graphics component 212, which may translate the throws information to graphics to be displayed (e.g., in AR or on any suitable display). The translation to graphics may be performed in real-time (e.g., to implement a head-to-head match between players in AR). In some aspects, the graphics may be generated based on previously recorded path data, as described. For example, a player may wish to play against a famous bowler, where path data for the famous bowler is pre-recorded and used to generate the graphics for display in AR. In some aspects, the AR overlay may include bowl path, posture of bowler bowling, video clips of the bowl, and/or scoring, based on data gathered in real-time or pre-recorded.

In some aspects, the analysis component 218 may provide path information (e.g., corresponding to test throws or virtual throws) to an automatic bowl thrower 216. For example, an automatic throwing machine may be used at a bowling lane to re-create a remote throw. The remote throw may correspond to an actual throw by a remote bowler identified using computer vision in real-time, a pre-recorded bowling path, a user-created bowling path, or a predicted bowling path as described herein. The bowl thrower 216 may take velocity and spin data from the analysis component 218 and propel the ball at a suitable speed and angle to achieve the throw. To recreate the bowl path by the bowl thrower 216, the throw may take into account lane quality analysis data to achieve an accurate result. In some aspects, the bowl thrower 216 may be located in a different bowling centre than cameras 206 to allow two bowlers to compete while at different bowling centres, as described herein. For example, the lane cameras 206 may capture videos or images a bowl of a first bowler at a first bowling facility. The videos or images may be processed by video processing component 208 and analysis component 218 to identify a path of the bowl as thrown by the first bowler. As described, path information may be sent to the bowl thrower 216 at a bowling centre of a second bowler so that the bowl thrower 216 can throw the bowl based on the path information.

In some aspects, combining path data with AR, a novelty bowling experience may be implemented using a 3D engine (e.g., graphics component 212). For example, an obstacle such as a virtual display of lava, may be added to areas of the lane that result in a score of 0 if hit. The bowler may be able to see the areas that are obstacles and try to avoid those areas when bowling. If an interaction with the obstacle occurs, the AR may provide visual or audio feedback (e.g., a bowl falling into a volcano with large eruption noise). For instance, if the bowl enters the obstacle area (e.g., interacts with the obstacle), the AR device of the bowler may show the bowl interacting with the obstacle, which may be in the form of a graphic such as an explosion, resulting in a lowered score.

In some aspects, an interactive bowl 204 may be used to increase engagement by providing the ability for the bowling lane and the bowl to interact physically with the AR experience. The graphics component 212 may provide a 3D model that includes one or more types of obstacles that can be visualized in AR (e.g., in AR device 220) and also form physical barriers in the game. For instance, lane-changing obstacles may be provided. The lane-changing obstacles may be raised areas of the lane. The graphics component 212 may generate graphics that virtually expand areas of the lane to provide a representation of a lump in the lane or at the end of the lane. The obstacles may be visualized in AR as hills or mountains in some aspects. A mechanical system may be provided on the lane similar to bumpers that may push the bowl in a particular direction if the bowl interacts with any obstacle shown in AR.

In some aspects of the present disclosure, the analysis component 218 may use path analysis based on videos of the bowling lane to identify quality issues associated with the lane (e.g., such as a warping of the lane surface). Bowling lanes are precision machines finely tuned to facilitate consistent play. Using path analysis, an objective measurement of lane quality can be achieved. For instance, the analysis component 218 may indicate that a bowling lane requires maintenance. Combining the lane quality assessment with the automated throwing via the bowl thrower 216 may allow bowling centres to automatically self-test the lane without human interaction. In other words, thrower 216 may be used to throw multiple bowls down a lane. The bowl movement may be captured using cameras and analysed by the analysis component 218 to identify issues with the lane.

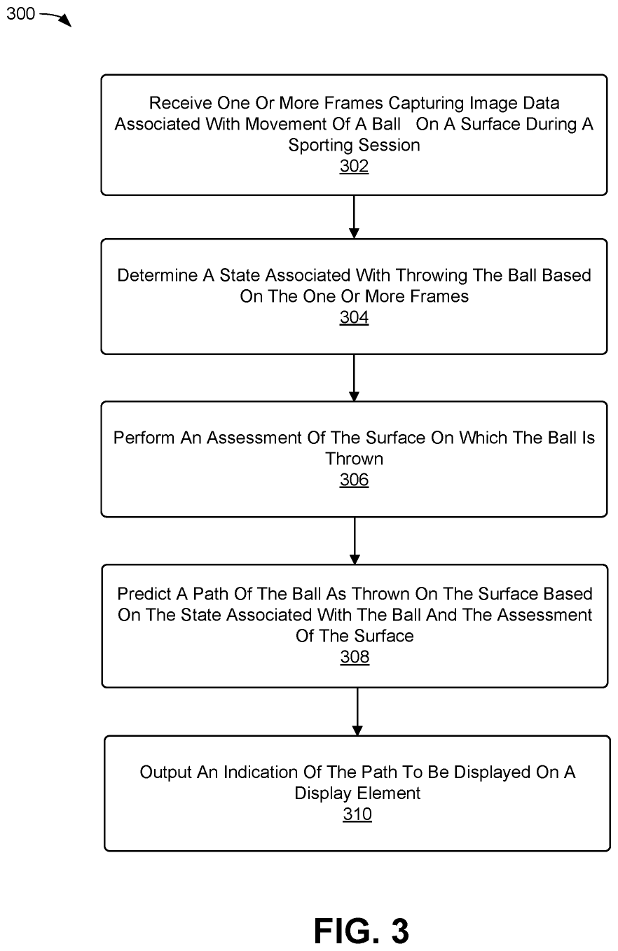

FIG. 3 illustrates example operations 300 for path analysis, in accordance with certain aspects of the present disclosure. The operations 300 may be performed, for example, by an engagement system, such as the engagement system 100.

At block 302, the engagement system receives one or more frames capturing image data associated with movement of a ball (e.g., a bowl) on a surface (e.g., bowling lane) during a sporting session. The one or more frames may include multiple frames captured from one or more perspectives from one or more cameras.

At block 304, the engagement system determines a state associated with throwing the ball based on the one or more frames. The state associated with throwing the ball may include a posture of a person throwing the ball prior to the ball being thrown. In some cases, the state associated with throwing the ball may include at least one of a position, motion, or spin associated with the ball.

At block 306, the engagement system performs an assessment of the surface on which the ball is thrown. At block 308, the engagement system predicts a path of the ball as thrown on the surface based on the state associated with the ball and the assessment of the surface.

At block 310, the engagement system outputs an indication of (e.g., graphics data showing) the path to be displayed on a display element. The indication of the path may be graphics data outputted to an augmented reality device.

In some aspects, the engagement system may include an automatic ball throwing device (e.g., projectile system 154 shown in FIG. 1) to throw a second ball on the path. In some aspects, the engagement system may generate graphics showing an obstacle on the surface and output the graphics to be displayed as an overlay on imagery of the surface. The graphics may be displayed on a display of an AR device. The engagement system may determine whether the ball interacts with a virtual representation of the obstacle on the surface and outputs an indication of the contact. For instance, the engagement system may output a control signal to a haptic device. The control signal may cause the haptic device to change a direction of travel associated with the ball.

In some aspects, to perform the assessment of the surface, the engagement system may identify a quality of the surface based on the one or more frames and output an indication of the quality of the surface. For instance, the engagement system may estimate a time when the surface will need to be maintained based on the quality of the surface and output an indication of the time. For example, identifying the quality of surface may involve identifying any warping of the surface which may impact the path of the bowling ball as it moves down the surface. Other examples of surface quality may include areas of high friction. In some cases, the quality of the surface may be identified based on movement of the ball on the surface. For instance, if the ball is traveling straight on the surface with no spin and the direction of the ball suddenly changes, this may be an indication that the surface is warped, causing the change in direction.

In some cases, a bowl response obstacle may be implemented to increase engagement in the sport. The bowl response obstacle may be implemented with an interactive bowl 204 having a processor and haptic feedback model that allows software to trigger movement in the ball as it moves. The bowl may also include a receiver, allowing the bowl to receive instructions from the graphics component 212, as shown. Based on the instructions, bowl 204 may bounce when hitting certain obstacles generating a change in direction. In some cases, the bowl may include a battery and circuitry for wireless charging of the battery.

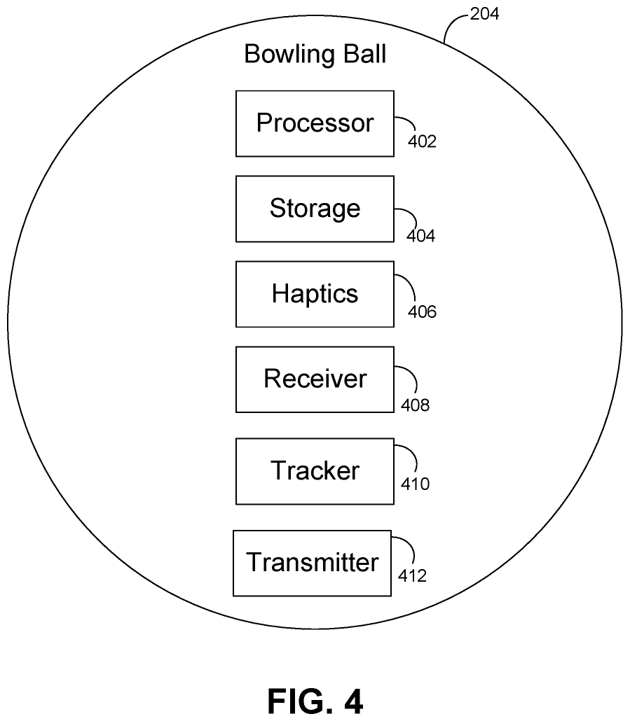

FIG. 4 is a block diagram illustrating example components of a bowl 204, in accordance with certain aspects of the present disclosure. As shown, bowl 204 may include a processor 402 and a storage 404. The storage 404 may include instructions, which when executed by the processor 402, operate a haptic device 406 of the bowl 204. For example, haptic device 406 may cause bowl 204 to move in a particular direction in response to an interaction of bowl 204 with an obstacle as described herein. In some cases, bowl 204 may include a receiver 408, which may receive signals indicating the interaction of the bowl with an obstacle. In some cases, the receiver may also receive instruction indicating a movement pattern to be implemented for the bowl and used to operate the haptic device 406. For instance, the movement pattern may include a direction of travel and a shaking of the bowl. In some aspects, the bowl 204 may be trackable. For example, a pattern may be printed on an outer surface of the ball that facilitates external cameras (e.g., cameras external to the bowling ball) to track the movement and spin of the bowling ball. In some cases, the bowl 204 may include a tracking element 410. The tracking element 410 may be used to track a position, motion, and/or spin of the bowling ball. The bowl 204 may include transmitter 412 which may be used to transmit the tracking information gathered by the tracking element 410, facilitating path prediction as described herein.

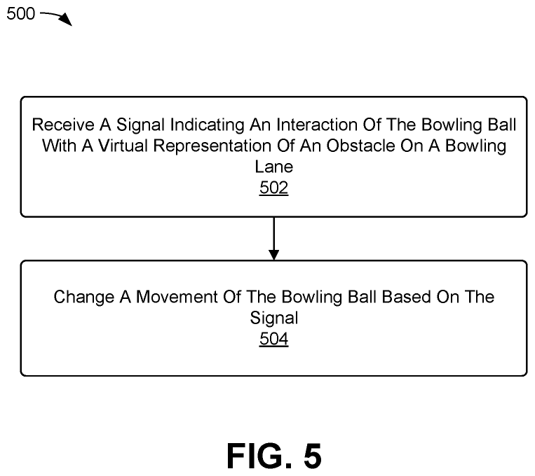

FIG. 5 illustrates example operations 500 for interactive bowling, in accordance with certain aspects of the present disclosure. The operations 500 may be performed, for example, by an interactive bowling ball, such as the bowl 204.

At block 502, the interactive bowling ball may receive (e.g., via receiver 408) a signal indicating an interaction of the bowling ball with a virtual representation of an obstacle on a bowling lane. At block 504, the interactive bowling ball may change (e.g., via a haptic device 406) a movement of the bowling ball based on the signal.

In some aspects, the interactive bowling ball may include a processor (e.g., processor 402) coupled to the haptic device. The processor may identify a movement pattern associated with the bowling ball based on the signal and control the haptic device to cause the movement of the bowling ball based on the movement pattern. In some cases, an outer surface of the bowling ball may include a non-symmetrical pattern to allow the bowling ball to be tracked (e.g., by external cameras and computer vision). In some aspects, the interactive bowling ball may include a tracking element configured to send (e.g., transmitter 412) tracking information for the bowling ball.

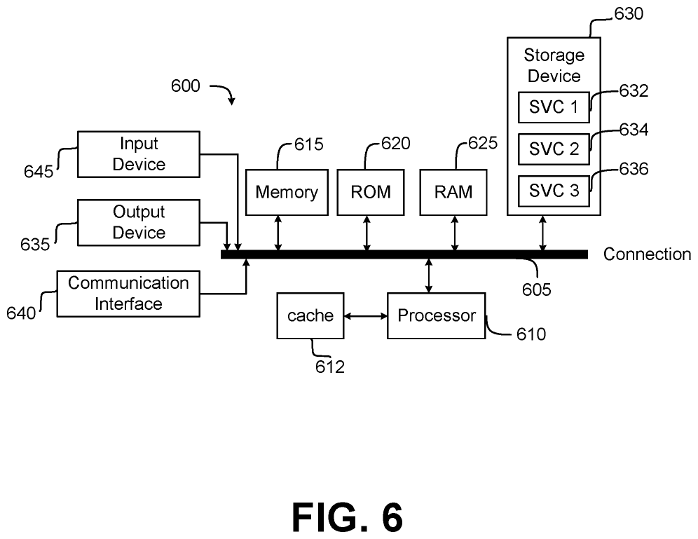

FIG. 6 illustrates an architecture of a computing system 600 wherein the components of the system 600 are in electrical communication with each other using a connection 605, such as a bus. Exemplary system 600 includes a processing unit (CPU or processor) 610 and a system connection 605 that couples various system components including the system memory 66, such as read only memory (ROM) 620 and random access memory (RAM) 625, to the processor 610. The system 600 can include a cache of high-speed memory connected directly with, in close proximity to, or integrated as part of the processor 610. The system 600 can copy data from the memory 66 and/or the storage device 630 to the cache 612 for quick access by the processor 610. In this way, the cache can provide a performance boost that avoids processor 610 delays while waiting for data. These and other modules can control or be configured to control the processor 610 to perform various actions. Other system memory 66 may be available for use as well. The memory 615 can include multiple different types of memory with different performance characteristics. The processor 610 can include any general purpose processor and a hardware or software service, such as service 1 632, service 2 634, and service 3 636 stored in storage device 630, configured to control the processor 610 as well as a special-purpose processor where software instructions are incorporated into the actual processor design. The processor 610 may be a completely self-contained computing system, containing multiple cores or processors, a bus, memory controller, cache, etc. A multi-core processor may be symmetric or asymmetric.

To enable client interaction with the computing system 600, an input device 645 can represent any number of input mechanisms, such as a microphone for speech, a touch-sensitive screen for gesture or graphical input, keyboard, mouse, motion input, speech and so forth. An output device 635 can also be one or more of a number of output mechanisms known to those of skill in the art. In some instances, multimodal systems can enable a client to provide multiple types of input to communicate with the computing system 600. The communications interface 640 can generally govern and manage the client input and system output. There is no restriction on operating on any particular hardware arrangement and therefore the basic features here may easily be substituted for improved hardware or firmware arrangements as they are developed.

Storage device 630 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 625, read only memory (ROM) 620, and hybrids thereof.

The storage device 630 can include services 632, 634, 636 for controlling the processor 610. Other hardware or software modules are contemplated. The storage device 630 can be connected to the system connection 605. In one aspect, a hardware module that performs a particular function can include the software component stored in a computer-readable medium in connection with the necessary hardware components, such as the processor 610, connection 605, output device 635, and so forth, to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the concepts in this disclosure may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” or “one or more of” a set indicates that one member of the set or multiple members of the set satisfy the claim. For example, claim language reciting “at least one of A and B” means A, B, or A and B.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules.

What is claimed is:

1. An apparatus for path analysis, comprising:
a memory; and
one or more processors coupled to the memory, the one or more processors being configured to:
receive one or more frames capturing image data associated with movement of a ball on a surface during a sporting session;
determine a state associated with throwing the ball based on the one or more frames;
perform an assessment of the surface on which the ball is thrown;
predict a path of the ball as thrown on the surface based on the state associated with the ball and the assessment of the surface; and
output an indication of the path to be displayed on a display element.

2. The apparatus of claim 1, wherein the state associated with throwing the ball comprises a posture of a person throwing the ball prior to the ball being thrown.

3. The apparatus of claim 1, wherein the state associated with throwing the ball comprises at least one of a position, motion, or spin associated with the ball.

4. The apparatus of claim 1, wherein the ball comprises a bowl, and wherein the surface comprises a bowling lane surface.

5. The apparatus of claim 1, wherein the one or more processors are further configured to control an automatic ball throwing device to throw a second ball on the path.

6. The apparatus of claim 1, wherein the indication of the path to be displayed includes graphics data.

7. The apparatus of claim 6, wherein the graphics data is outputted to an augmented reality device.

8. The apparatus of claim 1, wherein the one or more processors are further configured to:
generate graphics showing an obstacle on the surface; and
output the graphics to be displayed as an overlay on imagery of the surface.

9. The apparatus of claim 8, wherein the graphics are displayed on a display of an augmented reality (AR) device.

10. The apparatus of claim 8, wherein the one or more processors are further configured to:
determine whether the ball interacts with a virtual representation of the obstacle on the surface; and
output an indication of the interaction.

11. The apparatus of claim 10, wherein, to output the indication of the interaction, the one or more processors are configured to output a control signal to a haptic device.

12. The apparatus of claim 11, wherein the control signal causes the haptic device to change a direction of travel associated with the ball.

13. The apparatus of claim 1, wherein:
to perform the assessment of the surface, the one or more processors are configured to identify a quality of the surface based on the one or more frames; and
the one or more processors are further configured to output an indication of the quality of the surface.

14. The apparatus of claim 13, wherein the one or more processors are further configured to:
estimate a time when the surface will need to be maintained based on the quality of the surface; and
output an indication of the time.

15. The apparatus of claim 1, wherein the one or more frames comprise multiple frames captured from one or more perspectives from one or more cameras.

16. A bowling ball, comprising:
a receiver configured to receive a signal indicating an interaction of the bowling ball with a virtual representation of an obstacle on a bowling lane; and
a haptic device coupled to the receiver, wherein the haptic device is configured to change a movement of the bowling ball based on the signal.

17. The bowling ball of claim 16, further comprising a processor coupled to the haptic device, wherein the processor is configured to:
identify a movement pattern associated with the bowling ball based on the signal; and
control the haptic device to cause the movement of the bowling ball based on the movement pattern.

18. The bowling ball of claim 16, wherein an outer surface of the bowling ball includes a non-symmetrical pattern to allow the bowling ball to be tracked.

19. A system for path analysis, comprising:
a movement assessment component configured to determine a state associated with throwing a ball based on one or more frames capturing image data associated with movement of the ball on a surface during a sporting session;
a surface assessment component communicably coupled to the movement assessment component and configured to perform an assessment of the surface on which the ball is thrown; and
a path prediction component communicably coupled to the movement assessment component and the surface assessment component, the path prediction component being configured to:
predict a path of the ball as thrown on the surface based on the state associated with the ball and the assessment of the surface; and
output an indication of the path to be displayed on a display element.

20. The system of claim 19, wherein the state associated with throwing the ball comprises a posture of a person throwing the ball prior to the ball being thrown.
